(19) United States
(12) Patent Application Publication
(10) Pub. No.: US 2010/0238642 A1
(43) Pub. Date: Sep. 23, 2010

(54) SUPPORT TO FIX ELECTRICAL CABLES ON A STRUCTURE

(75) Inventors: Amelie Le Louarn, Tournefeuille (FR); Emmanuel Vilain, Toulouse (FR)

Correspondence Address: Perman & Green, LLP, 99 Hawley Lane, Stratford, CT, 06614, US

(73) Assignee: AIRBUS FRANCE, Toulouse (FR)

(21) Appl. No.: 12/376,639

(22) PCT Filed: Aug. 17, 2007
(86) PCT No.: PCT/FR07/51821

§ 371 Date: Jun. 7, 2010

(30) Foreign Application Priority Data
Aug. 17, 2006 (FR) 06 53393
Aug. 17, 2007 (FR) PCT/FR2007/051821

(51) Int. Cl. H02G 3/02

(52) U.S. Cl. 361/825

(57) ABSTRACT

A support for holding a cable harness capable of being attached to a structure to hold the aforementioned harness in position and orientation with respect to the aforementioned structure. The aforementioned support comprises means of positioning and holding the harness close to means of connecting the support to the structure and rails that extend on either side of the means, substantially in the direction in which the harness must be held. Each rail is attached to the aforementioned first means at one end and free at the other end.

### CROSS-REFERENCE TO RELATED APPLICATIONS

This application is the National Stage of International Application No. PCT/FR2007/051821, which designated the United States of America, and which International Application was published under PCT Article 21 (s) as WO Publication No. WO2008/020147 A2 and which claims priority from, and the benefit of, French Application No. 200653393 filed 17 Aug. 2006, the disclosures of which are incorporated herein by reference in their entireties.

The aspects of the disclosed embodiments belong to the field of the supports used for attaching electric wiring harnesses to structures. More specifically, the aspects of the disclosed embodiments relate to a kind of support which is able to reduce the length over which the electric wiring harnesses are unsupported between two adjacent supports and finds a particular application in vehicles in which vibrations and the proximity of other structures or equipment could cause damage to the cables.

### BACKGROUND

On board vehicles, electric wiring harnesses are generally held by retaining elements or supports 10, for example clamps like the one illustrated in FIG. 1a, which are themselves attached to structural elements, for example, in an airplane, to fuselage frames or floor beams. Usually, the structures to which these supports can be attached are limited and are spaced apart by a distance which may be great considering the lack of rigidity of the cables. This spacing between two structures, and therefore between two supports, causes the electric wiring harnesses to deflect or sag under the effect of their own weight. For example, if the spacing L between two structures, and therefore between two supports 10, is 450 mm, which is a common spacing between two airplane fuselage frames, the deflection d by which the wiring harness sags is approximately 13 mm, as illustrated in FIG. 1b.

Deformation entails a lengthening of the overall length of the electric wiring harnesses, which proves disruptive to control of installation.

In addition, if surrounding structures are relatively close to the harnesses, the deflection may cause contact between the harnesses and said surrounding structures. Such contacts, especially in a vibrational environment, may lead to wear of the insulation of the electric cables and lead to disruptions in the operation of the electric circuits such as losses of signals or short circuits. At the present time, in order to avoid contact between electric wiring harnesses and the surrounding structures, wiring harnesses are routed very carefully in order to maintain sufficient distance between the wiring harnesses and said structures given the possibility of said harnesses sagging.

When the position of the harnesses in space has to be controlled perfectly, it is also known practise to use rails, rigid supports which follow the desired path and which are fixed to the structure at several points. Such rails are heavier than the individual supports, are weaker and more difficult to install and are far more expensive to produce especially as they have to be tailored to each particular installation.

The use of supports that reduce the extent to which electric wiring harnesses sag between two supports without increasing the number or cost thereof is therefore an important issue in simplifying the operations of fitting and maintaining said harnesses.

### SUMMARY

The disclosed embodiments propose a support for attaching an electric wiring harness which holds the harnesses better than existing supports and reduces the deflection of the harnesses between two points of attachment of supports without altering the number of supports needed and without generating a significant mass or cost penalty.

According to the disclosed embodiments, a support for holding a wiring harness capable of being attached to a structure to maintain the position and orientation of said electric wiring harness with respect to said structure, comprises first means for positioning and holding the harness near to the means of connecting the support to the structure, and comprises at least one second harness positioning and holding means in the form of a rail which extends on either side of the first means, directed substantially in the direction in which the harness is to be held, said at least one rail being secured to said first means at one end and free at the other end.

In a preferred embodiment, the second means comprises at least two rails at least one of which is secured to said first means on one side and at least one other of which is secured to said first means on another side. The two rails may be substantially aligned or may make an angle between them.

For preference, in order to balance the weight of the harness on either side of the clamp, the rails are substantially the same length thus limiting the risks of pulling out at the fastenings that attach the support to the structure.

In order to ensure accurate positioning of the harness and continuity between the first means and the rails, the at least one rail has an upper surface on which the harness is positioned that is substantially planar or cylindrical with the generatrices resting substantially on a surface of the first means, on which said harness is held in position and in orientation in said first means.

In one embodiment, the first positioning and holding means form a substantially closed surface such as a clamp the cross section of the opening of which is advantageously tailored to the cross section of the harness.

In another embodiment, the first positioning and holding means form a concave open surface, for example V-shaped, said surface being closed by a means of attachment, such as a binding band that holds the harness on said surface, and the tightening of which allows it to suit different cross sections of harness.

Advantageously, at least one rail comprises, on a lower face, a reinforcement able to increase the rigidity of said at least one rail. The cross section and thickness of the rails and reinforcements assembly are tailored to withstand the weight of the harness.

For preference, the reinforcement comprises means for positioning means of attachment of the harness around at least one rail and for preventing said means of attachment from sliding along the at least one rail. The means may, for example, be a hole or a notch in the reinforcement.

In one embodiment, the support is made as a single piece, for example by injection molding.

In another embodiment, the elements, first and at least one second positioning and holding means, are produced separately then assembled, making it possible to produce modular supports by choosing the first means separately according to the diameter of the harness and the rails according to the distance between two adjacent supports.

### BRIEF DESCRIPTION OF THE DRAWINGS

The detailed description of the support for attaching an electric wiring harness is given with reference to the figures which depict:

FIG. 1a, a perspective schematic view of a support according to the prior art for attaching an electric wiring harness to structures,

FIG. 1b, an installation diagram for installing an electric wiring harness between two supports according to the prior art and of the resulting deflection,

FIG. 2, a perspective schematic view of a support according to the disclosed embodiments,

FIG. 3, a side view of a support according to the disclosed embodiments,

FIG. 4, a perspective view of a support according to the disclosed embodiments, viewed from the side of the face that is positioned against the structure,

FIG. 5a, 5b, 5c, 5d, various views of a support according to the disclosed embodiments illustrating examples of how the rails are arranged on the support,

FIG. 6, an installation diagram for installing an electric wiring harness between two supports according to the disclosed embodiments.

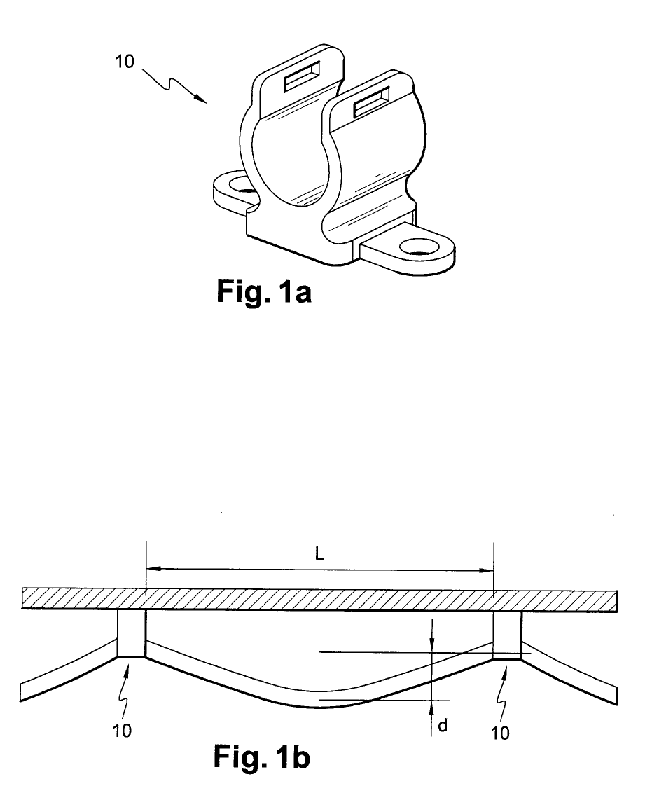

### DETAILED DESCRIPTION

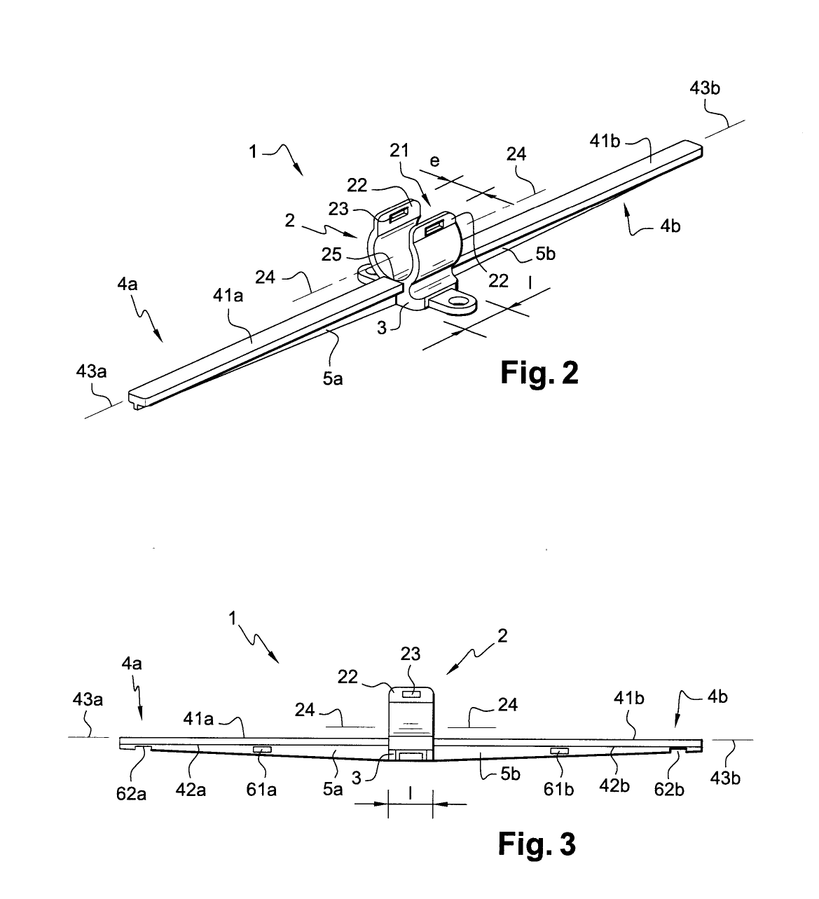

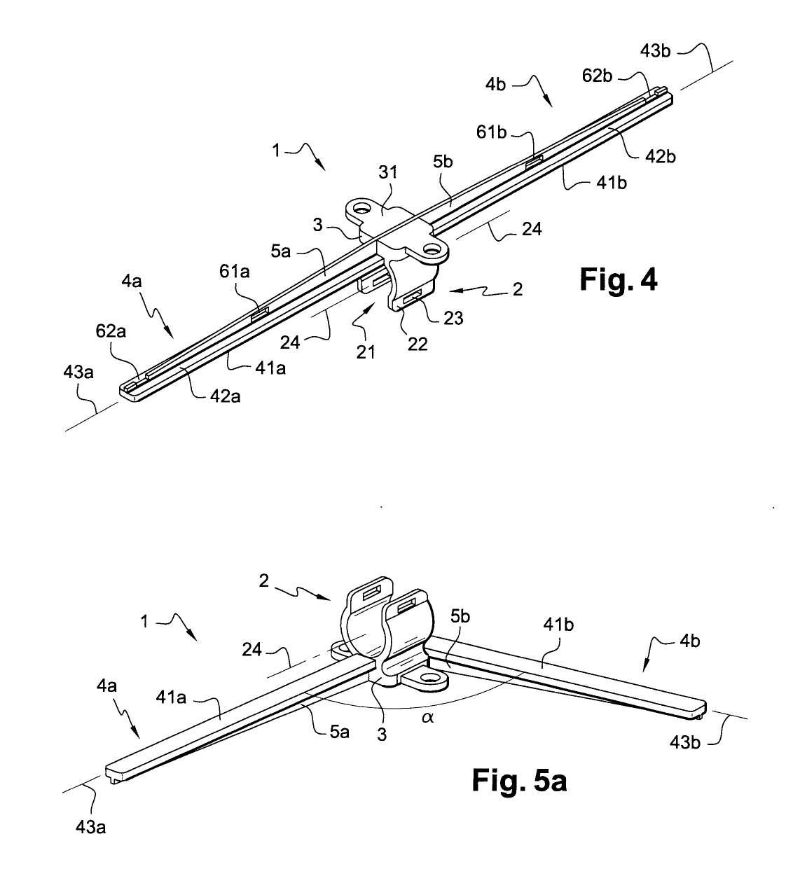

A support 1 for attaching an electric wiring harness to structures according to the disclosed embodiments, as illustrated in FIGS. 2, 3 and 4 which show various views of one and the same embodiment of a support and in which the electric wiring harness is not depicted, consists of:

a clamp 2 capable of accepting the electric wiring harness,

a mount 3 for attaching the support to a structure,

two lateral rails 4a, 4b.

In the example illustrated, the harness is placed in the clamp 2, on an interior surface 25, along an axis 24 of said clamp. Said clamp, of length l, is open on the opposite side to the mount 3 and the opening 21, of width e, has two ends 22 each with a rim comprising openings 23. Said openings 23 are used to feed through a binding band or some other means of attachment that can be used to tighten the clamp 2 by bringing the rims of the opening 21 closer together thus holding the harness in the clamp 2. The choice of clamp depends both on the diameter of the harness and on the weight thereof. Hence, the width e of the opening 21 of the clamp 2 is tailored to suit the diameter of the harness and the length l of the clamp 2 is tailored to suit the weight of the harness. Other shapes or means equivalent to the clamp 2 as depicted, for example V-shaped clamps, may also be used.

The mount 3 comprises a lower surface 31, which is advantageously planar, intended to be positioned against the structure (not depicted) to which the support is attached and provide it with stability. Said mount is attached to the structure by any conventional means, particularly by bonding of the lower surface, by screwing or by clipping.

The two lateral rails 4a, 4b are positioned one on each side of the clamp 2. Each rail is attached to the clamp at one end and free at the other end. Said lateral rails are of elongate shape. Each rail has an upper surface 41a, 41b situated on the side of the clamp. Said surfaces are substantially planar or cylindrical corresponding to extensions of all or part of the interior surface 25 of the clamp 2 situated on the side of the mount 3. In the exemplary embodiment illustrated in FIGS. 2, 3 and 4, the rails 4a, 4b are substantially aligned, with axes 43a, 43b substantially along the axis 24 of the clamp. Thus, an electric wiring harness which is placed in the clamp will naturally lie along the axes of said rails, on the same side as the upper surface 41a, 41b of each rail.

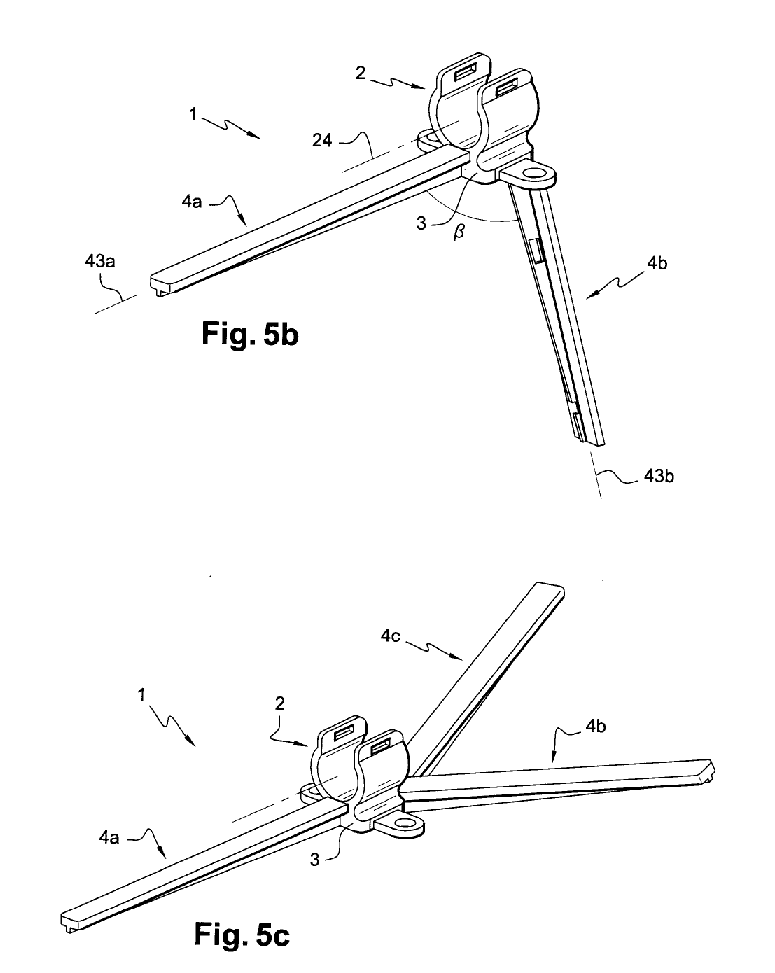

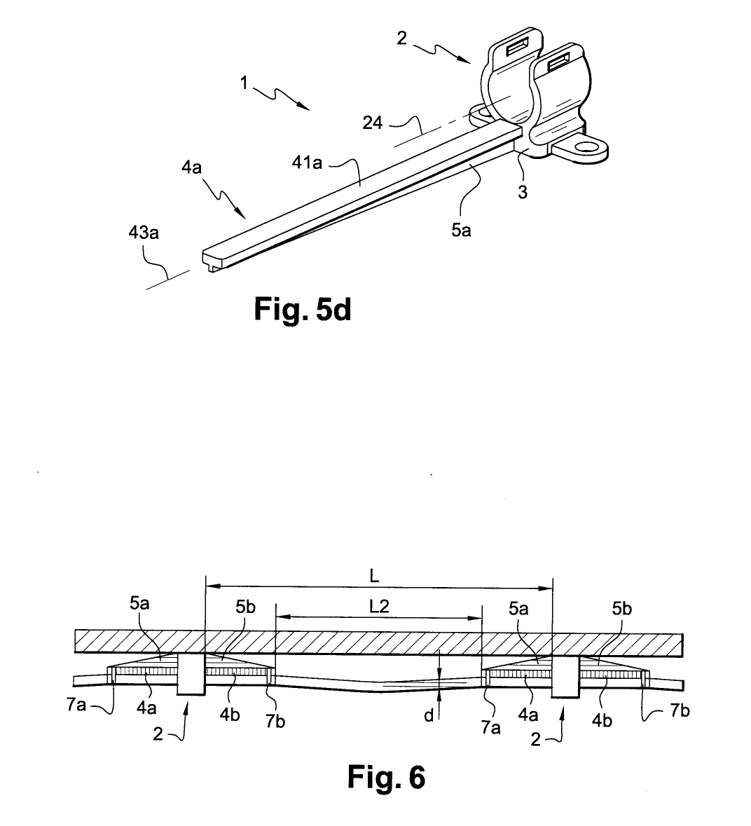

In an alternative form of embodiment as depicted in FIGS. 5a, 5b, the rails 4a, 4b are not aligned but make an angle between them in any plane. In the example of FIG. 5a, the rails 4a, 4b form an angle α in the plane formed by said two rails. In the example of FIG. 5b, in which the rail 4b is oriented differently than in the example of FIG. 5a, the rails 4a, 4b form an angle β in the plane formed by said two rails.

In another alternative form of embodiment, as shown in FIG. 5c, the clamp 1 has three rails 4a, 4b, 4c with, for example, the shape of a Y with one rail 4a on one side of the clamp and two rails 4b, 4c on the other side of the clamp.

In another alternative form of embodiment, as illustrated in FIG. 5d, the support 1 consists of a single lateral rail 4a. This special asymmetric shape is chiefly designed for supports 1 positioned at the ends of the cables.

The disclosed embodiments are not restricted to the rail examples described hereinabove by way of nonlimiting examples. A person skilled in the art will be able to adapt the disclosed embodiments to a number of rails on the support and to angles between said rails other than those described.

For preference, said rails have a substantially constant width so as to offer a wide enough surface on which the harness can rest.

The length of each rail 4a, 4b is tailored to suit the spacing between two structures. In one exemplary embodiment, it represents approximately one third of the average distance between two supports such that each free end of a rail determines an intermediate point substantially mid-way between the point of attachment to the support and the free end of the rail of the adjacent support. For preference, said rails exhibit symmetry with respect to the clamp 2 so as to balance the weight of the harness on each side of said clamp.

Advantageously, the rails, on a lower face 42a, 42b, have reinforcements 5a, 5b in the form of stiffeners secured to the mount 3. Said reinforcements allow the rails to be rigid enough to support the weight of the harness without the need for the rail thickness to be increased excessively. Each reinforcement 5a, 5b extends over all or part of the length of its associated rail 4a, 4b.

The rails 4a, 4b and reinforcements 5a, 5b assembly in fact behaves like a beam that is fixed at one end, and subjected to bending forces. The thickness and cross section of the rails and reinforcements assembly are therefore determined such that the rails and reinforcements assembly can withstand the weight of the harness subjected to the various accelerations of the structure to which the support is attached.

In one exemplary embodiment, in order to withstand relatively light bending forces, the reinforcement is of trapezoidal shape, being taller at its root near the mount than at the free end of the rail. This example minimizes the mass of the support.

In one exemplary embodiment, in order to withstand greater bending forces in the case of a heavier harness, the reinforcement is of hollow parallelepipedal shape or has any other cross section with a suitable second moment of area.

The disclosed embodiments are not restricted to the examples described hereinabove. A person skilled in the art will be able to adapt the shape and cross section of the rails and reinforcements assembly to shapes and cross sections that have not been described, particularly according to the weight of the harness that the rails and reinforcements assembly needs to be able to withstand and according to the material used to make the rails and reinforcements.

Advantageously, in order to avoid slippage of means 7a, 7b of attachment (depicted in FIG. 6), for example a binding band, that hold the electric wiring harnesses on the rails 4a, 4b, the reinforcements 5a, 5b have means 61a, 61b, 62a, 62b, for example a recess 61a, 61b or a notch 62a, 62b for positioning said means of attachment. The number of means is tailored, as needed, according to the length of the rails.

In a preferred embodiment, the supports 1 are made as a single piece comprising the clamp 2, the mount 3, the rails 4a, 4b and the reinforcements 5a, 5b. For example, said supports are made of a plastic, for example nylon, preferably by injection molding.

Another method is to produce the rails 4a, 4b with the reinforcements 5a, 5b separately and then assemble the two rail and reinforcement elements on each side of the mount 3. This method is suited to the production of modular supports in which the diameter of the clamp, the strength and/or the length of the rails are chosen according to the application.

In the already mentioned prior art example of an airplane with a spacing L of 450 mm between two structures, and with supports according to the disclosed embodiments, the spacing L2 over which the electric wiring harness is subjected to its own self weight, that is to say between the free ends of each rail, is reduced to 210 mm, as illustrated in FIG. 5. In such a case, the deflection becomes negligible.

The disclosed embodiments therefore make it possible to obtain a support 1 for attaching an electric wiring harness that holds the harness better and reduces the deflection or extent to which the harness sags between two supports without there being any need to alter the number of supports.

1. A support for holding a wiring harness capable of being attached to a structure to maintain the position and orientation of said electric wiring harness with respect to said structure, comprising first means for positioning and holding the harness near to the means of connecting the support to the structure, wherein said support comprises at least one second harness positioning and holding means in the form of a rail, directed substantially in the direction in which the harness is to be held, said at least one rail being secured to said first means at one of its ends and free at the other end.

2. The support as claimed in claim 1, in which the second means comprises at least two rails at least one of which is secured to said first means on one side and at least one other of which is secured to said first means on another side.

3. The support as claimed in claim 2, in which the two rails are substantially aligned.

4. The support as claimed in claim 2, in which the two rails form an angle between them.

5. The support as claimed in claim 2, in which the rails are of substantially the same length.

6. The support as claimed in claim 1, in which at least one rail has an upper surface on which the harness is positioned that is substantially planar or cylindrical with the generatrices resting substantially on a surface of the first means, on which said harness is held in position and in orientation.

7. The support as claimed in claim 1, in which the first positioning and holding means form a substantially closed surface such as a clamp.

8. The support as claimed in claim 1, in which the first positioning and holding means form a concave open surface, said surface being closed by a means of attachment, such as a binding band that holds the harness on said surface.

9. The support as claimed in claim 1, in which at least one rail comprises, on a lower face, a reinforcement able to increase the rigidity of at least one rail.

10. The support as claimed in claim 9, in which the reinforcement comprises means able to hold means of attachment of the harness on at least one rail.

11. The support as claimed in claim 10, in which the means are formed by a hole.

12. The support as claimed in claim 10, in which the means are formed by a notch.

13. The support as claimed in claim 1, in which said support is made as a single piece.

14. The support as claimed in claim 1 comprising a plurality of distinct elements, first and at least one second positioning and holding means which have been assembled.
